(19) United States
(12) Patent Application Publication
(10) Pub. No.: US 2014/0352792 A1
(43) Pub. Date: Dec. 4, 2014

(54) SYSTEM AND METHOD FOR CONTROLLING HYDROGEN CHARGING FOR VEHICLE

(71) Applicant: Hyundai Motor Company, Seoul (KR)

(72) Inventors: Ji Hyun Shim, Busan (KR); Hyung Ki Kim, Seoul (KR); Sang Hyun Kim, Seongnam, Gyeonggi-do (KR)

(73) Assignee: Hyundai Motor Company, Seoul (KR)

(21) Appl. No.: 14/050,665

(22) Filed: Oct. 10, 2013

(30) Foreign Application Priority Data
Jun. 3, 2013 (KR) 10-2013-0063380

(51) Int. Cl. G05D 7/06

(52) U.S. Cl. CPC G05D 7/0623
USPC 137/2; 137/487.5

(57) ABSTRACT

A system and method for controlling hydrogen charging for vehicles are provided. The system includes a hydrogen sensor configured to detect a leak in a hydrogen tank and a controller configured to stop an inflow of hydrogen into the hydrogen tank when a hydrogen concentration value detected by the hydrogen sensor is a reference value or greater.

### CROSS-REFERENCE TO RELATED APPLICATION

This application claims under 35 U.S.C. §119(a) priority to Korean Patent Application No. 10-2013-0063380 filed Jun. 3, 2013, the entire contents of which are incorporated herein by reference.

### BACKGROUND

1. Field of the Invention

The present invention relates, in general, to a system and method for controlling hydrogen charging for vehicles, and more particularly, to a system and method for controlling hydrogen charging for vehicles which receives information from a hydrogen sensor and, when the detected concentration of hydrogen is a certain value or greater, sends a control signal to a charger to stop the delivery of hydrogen.

2. Description of the Related Art

Development of environmentally friendly vehicles is progressing in a variety of directions. Examples of environmentally friendly vehicles include hybrid vehicles, vehicles using a hydrogen fuel cell, electric vehicles (EVs) which run on a battery and a motor, and the like. In particular, among a variety of environmentally friendly vehicles, development of vehicles using a hydrogen fuel cell is gaining more attention due to the required resources not being limited, environmental pollution does not occur, and charging time is not a concern, unlike electric vehicles.

However, it may be difficult to maintain the fuel of a hydrogen fuel cell in a compressed state due to the characteristics of hydrogen, and the danger of explosion exists. Therefore, a pressure vessel must be used, and a device for detecting a hydrogen gas leak from the pressure vessel must be equipped. However, the techniques developed in the related art may not have the ability to stop the delivery of hydrogen from a charger when a leak occurs while the hydrogen is being charged.

The information disclosed in this section is only for the enhancement of understanding of the background of the invention, and should not be taken as an acknowledgment or any form of suggestion that this information forms a prior art that would already be known to a person skilled in the art.

### SUMMARY

Accordingly, the present invention provides a system and method for controlling hydrogen charging for vehicles which may detect a hydrogen leak using a hydrogen sensor and, when the detected concentration of hydrogen is a certain value or greater, may send a hydrogen delivery stop signal to a charger to stop the supply of hydrogen to a vehicle.

According to one aspect of the present invention, a system for controlling hydrogen charging for vehicles may include: a hydrogen sensor which detects a leak in a hydrogen tank; and a controller configured to stop inflow of hydrogen into the hydrogen tank when a hydrogen concentration value detected by the hydrogen sensor is a reference value or greater.

According to an exemplary embodiment of the present invention, the hydrogen sensor may be disposed on a pressure pipe that connects a hydrogen inlet to the hydrogen tank. The controller may be configured to operate a hydrogen charger to stop inflow of hydrogen to the hydrogen tank when the detected hydrogen concentration value is reference value or greater. In particular, the controller may be configured to operate the hydrogen charger via wireless communication.

The system may further include a cutoff valve disposed on a pressure pipe which connects a hydrogen inlet to the hydrogen tank. The controller may be configured to operate the cutoff valve to stop inflow of hydrogen into the hydrogen tank when the detected hydrogen concentration value is reference value or greater. The controller may be configured to start detecting the hydrogen concentration value when the fuel door of a vehicle is opened.

According to another aspect of the present invention, a method for controlling hydrogen charging for vehicles may include: detecting a leak in a hydrogen tank using a hydrogen sensor; comparing, by a controller, a hydrogen concentration value detected by the hydrogen sensor with a predetermined reference value; and operating, by the controller, hydrogen charging to be stopped when the detected hydrogen concentration value is the reference value or greater.

According to an exemplary embodiment of the present invention, operating the hydrogen charging to be stopped may include operating a hydrogen charger to stop the inflow of hydrogen into the hydrogen tank when the detected hydrogen concentration value is the reference value or greater.

According to the system and method for controlling hydrogen charging having the above-described configuration, when a leak occurs during high-pressure hydrogen charging, the vehicle may autonomously detect the leak and stop the charging by sending a signal to the charger without requiring a driver's operation. It is therefore possible to improve the safety of the driver and the person who charges the vehicle. In addition, since the vehicle may detect a hydrogen leak and a detection position may be set to an optimum position, it may be possible to rapidly respond to a small concentration of hydrogen leakage, thereby stopping charging.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is an exemplary configuration view showing a system for controlling hydrogen charging for vehicles according to an exemplary embodiment of the present invention; and

FIG. 2 is an exemplary flowchart showing a method for controlling hydrogen charging for vehicles according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Reference will now be made in greater detail to a system and method for controlling hydrogen charging for vehicles according to the present invention, exemplary embodiments of which are illustrated in the accompanying drawings.

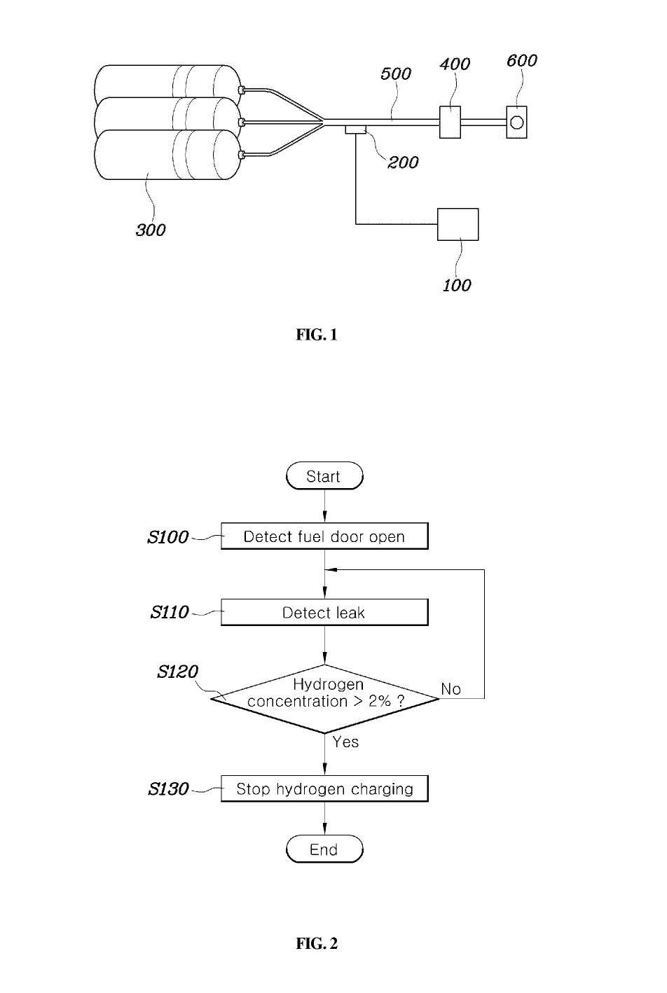

FIG. 1 is an exemplary configuration view showing a system for controlling hydrogen charging for vehicles according to an exemplary embodiment of the present invention. The system may include a hydrogen sensor 200 configured to detect a leak in hydrogen tanks 300 and a controller 100 configured to stop the inflow of hydrogen into the hydrogen tanks 300 when a hydrogen concentration value detected by the hydrogen sensor 200 is a reference value or greater. Specifically, the hydrogen sensor 200 may be disposed on a pressure pipe 500 that connects a hydrogen inlet 600 to the hydrogen tanks 300 or around the hydrogen tanks 300, and may be configured to detect a hydrogen leak occurring in a solenoid valve connected to a hydrogen tank 300, a fitting or a variety of valves by detecting hydrogen in the air.

In addition, the operation of detecting hydrogen may be performed when the fuel door of a vehicle is opened. Since the operation of detecting hydrogen may be performed when the fuel door of the vehicle is opened, the operation of detecting hydrogen may not be performed when hydrogen charging is not being performed, for example, in a parked position, without consuming the power of a battery. It may therefore be possible to prevent the battery from being discharged and reduce unnecessary power consumption.

The output value of the hydrogen sensor 200 that is output by a voltage may produce a hydrogen concentration percent with respect to the surrounding air by referring to predetermined map data stored in the controller 100. Therefore, the hydrogen concentration value detected by the hydrogen sensor 200 may be represented as a percent. In addition, when the detected hydrogen concentration value is the predetermined reference value or greater, the controller 100 may be configured to stop the inflow of hydrogen into the hydrogen tanks 300. In particular, the predetermined reference value may be the hydrogen concentration in the air that may be about 2%. Since the reference value may be set to about 2%, a hydrogen leak may be detected before the hydrogen concentration in the air exceeds about 4% in which hydrogen may ignite in the air. This may consequently prevent an accident from being caused by a hydrogen leak.

In addition, when the detected hydrogen concentration value is the reference value or greater, the controller 100 may be configured to operate a hydrogen charger to stop the inflow of hydrogen into the hydrogen tanks 300. Specifically, when the detected hydrogen concentration value is the reference value or greater, the controller 100 may be configured to send a control signal to the hydrogen charger via infrared radiation (IR) communication or another wireless communication means. Upon receiving the control signal, the hydrogen charger may be configured to stop the delivery of hydrogen to the hydrogen tanks 300. Therefore, when the controller 100 has determined that hydrogen is leaking, the operation of the hydrogen charger may be operated to prevent hydrogen from being supplied to the vehicle, thereby preventing hydrogen from additionally leaking during hydrogen charging and ensuring that the vehicle and occupants are safe.

In addition to the above-described configuration of controlling the hydrogen charger, a cutoff valve 400 may be mounted on the pressure pipe 500 which connects the hydrogen inlet 600 to the hydrogen tanks 300. When the hydrogen concentration value is the reference value or greater, the controller 100 may be configured to operate the cutoff valve 400 to stop the inflow of hydrogen into the hydrogen tanks 300. The cutoff valve 400 may be operated together with the hydrogen charger or may be operated separately. Accordingly, in the case of an emergency, the vehicle or an in-vehicle device may autonomously stop hydrogen charging independently from the charger. Therefore, even when the hydrogen charger does not stop charging due to an error in the wireless communication of the controller 100 or a malfunction, it may be possible to stop the inflow of hydrogen into the vehicle and ensure that the vehicle and occupants are safe.

FIG. 2 is an exemplary flowchart showing a method for controlling hydrogen charging for vehicles according to an exemplary embodiment of the present invention. The method may include a detection step S110 of detecting a leak in the hydrogen tanks 300 using the hydrogen sensor 200, a comparison step S120 of comparing, by a controller, a hydrogen concentration value detected by the hydrogen sensor 200 with a predetermined reference value, and a control step S130 of operating, by the controller, hydrogen charging to be stopped when the detected hydrogen concentration value is the reference value or greater.

Specifically, when the fuel door of the vehicle is detected at S100, the detection step S110 of detecting a leak in the hydrogen tanks 300 using the hydrogen sensor 200 may be performed. Afterwards, the comparison step S120 of determining whether the hydrogen concentration value detected in the detection step is the predetermined reference value or greater may be performed. When the detected hydrogen concentration value is the reference value or greater, the control step S130 of operating hydrogen charging to be stopped may be performed. The control step S130 may be configured to stop the inflow of hydrogen into the hydrogen tanks 300 by operating the hydrogen charger or the cutoff valve 400 of the vehicle when the detected hydrogen concentration value is the reference value or greater. In addition, both of the two schemes may be performed concurrently.

According to the system and method for controlling hydrogen charging having the above-described configuration, when a leak occurs during high-pressure hydrogen charging, the vehicle may autonomously detect the leak and stop charging by sending a signal to the charger without requiring a driver's operation. It may therefore be possible to improve the safety of the driver and the person who charges the vehicle. In addition, since the vehicle may detect a hydrogen leak and a detection position may be set to an optimum position, it may be possible to rapidly respond to a small concentration of hydrogen leakage, thereby stopping charging.

Although the exemplary embodiments of the present invention have been described for illustrative purposes, those skilled in the art will appreciate that various modifications, additions and substitutions are possible, without departing from the scope and spirit of the present invention as disclosed in the accompanying claims.

What is claimed is:

1. A system for controlling hydrogen charging for vehicles comprising:
a hydrogen sensor configured to detect a leak in a hydrogen tank; and
a controller configured to stop an inflow of hydrogen into the hydrogen tank when a hydrogen concentration value detected by the hydrogen sensor is a reference value or greater.

2. The system according to claim 1, wherein the hydrogen sensor is disposed on a pressure pipe that connects a hydrogen inlet to the hydrogen tank.

3. The system according to claim 1, wherein the controller is further configured to operate a hydrogen charger to stop the inflow of hydrogen to the hydrogen tank when the detected hydrogen concentration value is reference value or greater.

4. The system according to claim 3, wherein the controller is further configured to operate the hydrogen charger via wireless communication.

5. The system according to claim 1, further comprising:
a cutoff valve disposed on a pressure pipe that connects a hydrogen inlet to the hydrogen tank,
wherein the controller is configured to operate the cutoff valve to stop the inflow of hydrogen into the hydrogen tank when the detected hydrogen concentration value is the reference value or greater.

6. The system according to claim 1, wherein the controller is further configured to start detecting the hydrogen concentration value when a fuel door of a vehicle is opened.

7. A method for controlling hydrogen charging for vehicles comprising:
detecting, by a hydrogen sensor, a leak in a hydrogen tank;
comparing, by a controller, a hydrogen concentration value detected by the hydrogen sensor with a predetermined reference value; and
operating, by the controller, hydrogen charging to be stopped when the detected hydrogen concentration value is the predetermined reference value or greater.

8. The method according to claim 7, wherein operating the hydrogen charging to be stopped includes:
operating, by the controller, a hydrogen charger to stop an inflow of hydrogen into the hydrogen tank when the detected hydrogen concentration value is the predetermined reference value or greater.

9. The method according to claim 7, wherein the hydrogen sensor is disposed on a pressure pipe that connects a hydrogen inlet to the hydrogen tank.

10. The method according to claim 8, further comprising:
operating, by the controller, the hydrogen charger via wireless communication.

11. The method according to claim 7, further comprising:
operating, by the controller, a cutoff valve disposed a pressure pipe that connects a hydrogen inlet to the hydrogen tank to stop the inflow of hydrogen into the hydrogen tank when the detected hydrogen concentration value is the predetermined reference value or greater.

12. The method according to claim 7, further comprising:
starting, by the controller, detecting the hydrogen concentration value when a fuel door of a vehicle is opened.

13. A non-transitory computer readable medium containing program instructions executed by a controller, the computer readable medium comprising:
program instructions that control a hydrogen sensor to detect a leak in a hydrogen tank;
program instructions that compare a hydrogen concentration value detected by the hydrogen sensor with a predetermined reference value; and
program instructions that operate hydrogen charging to be stopped when the detected hydrogen concentration value is the predetermined reference value or greater.

14. The non-transitory computer readable medium of claim 13, further comprising:
program instructions that operate a hydrogen charger to stop an inflow of hydrogen into the hydrogen tank when the detected hydrogen concentration value is the predetermined reference value or greater.

15. The non-transitory computer readable medium of claim 13, wherein the hydrogen sensor is disposed on a pressure pipe that connects a hydrogen inlet to the hydrogen tank.

16. The non-transitory computer readable medium of claim 14, further comprising:
program instructions that operate the hydrogen charger via wireless communication.

17. The non-transitory computer readable medium of claim 13, further comprising:
program instructions that operate a cutoff valve disposed a pressure pipe that connects a hydrogen inlet to the hydrogen tank to stop the inflow of hydrogen into the hydrogen tank when the detected hydrogen concentration value is the predetermined reference value or greater.

18. The non-transitory computer readable medium of claim 13, further comprising:
program instructions that start detecting the hydrogen concentration value when a fuel door of a vehicle is opened.
